(19) United States
(12) Patent Application Publication
(10) Pub. No.: US 2026/0190189 A1
(43) Pub. Date: Jul. 2, 2026

(54) COOKING APPLIANCE AND METHODS OF OPERATING COOKING APPLIANCE

(71) Applicant: CHEFAI LLC, Vancouver, WA (US)

(72) Inventors: Maxwell Heng Deng, Vancouver, WA (US); Dean Yar Khormaei, Sunnyvale, CA (US); Aaron Kemper, Portland, OR (US); Max Chakhmatov, San Francisco, CA (US)

(21) Appl. No.: 19/398,505

(22) Filed: Nov. 24, 2025

Related U.S. Application Data
(60) Provisional application No. 63/740,869, filed on Dec. 31, 2024.

(51) Int. Cl. H05B 6/64

(52) U.S. Cl. CPC H05B 6/6455; H05B 6/6435; H05B 6/6464

(57) ABSTRACT

A method for operating a cooking appliance with a range of sensors and components to determine relevant cooking information related to a food item, cooking the food item, and adjusting cooking information as new information is gathered. A cooking appliance that determines how to cook a food item based on data collected from the user, sensors that determine the physical characteristics of a food item, and historical data collected from previous cooking sessions.

### CROSS-REFERENCE TO RELATED APPLICATION

This U.S. non-provisional patent application claims the benefit of U.S. provisional patent application Ser. No. 63/740,869, filed Dec. 31, 2024, which is incorporated herein by reference in its entirety.

### BACKGROUND

Convenient and time-efficient meal preparation solutions have taken different form factors, from delivery of pre-made dishes to fast cooking devices such as microwave ovens. Current solutions can be expensive, inefficient, require multiple user interventions, and can produce less than satisfactory user experiences.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed relating to cooking appliances and cooking systems, and methods for operating a cooking appliance to address one or more drawbacks of previous solutions. In some examples, configurations of the present disclosure include a method for operating a cooking appliance to cook a food item. The cooking appliance comprises one or more visible light cameras, one or more infrared sensors, and one or more force transducers. The method comprises determining an external temperature of a surface of the food item using data from the infrared sensor(s). An internal temperature of the food item is estimated using the external temperature, and the food item is classified as a predicted food class from a plurality of food classes using image data from the visible light camera(s).

A weight of the food item is determined using signals and/or data from the force transducer(s). Using at least the internal temperature, the predicted food class, and the weight of the food item, a temperature profile of the food item is generated. Using at least the temperature profile, a cooking time and a cooking temperature for the food item are determined, and the cooking appliance is operated to cook the food item at the cooking temperature for the cooking time.

As described in more detail below, in some examples, a camera located above the device tray captures a visible image of the food item. The image data is passed to a machine learning vision model that classifies the image. The image data is also used to detect the area of the food item. For example, by comparing the amount of area that is encompassed by the food item to the background of the cooking tray, the area is calculated. Weight sensors, such as force transducers, in the device determine the weight of the food item. For some food items, using an experimentally found density of the identified food, the thickness of the food item is calculated using the food item's area and density value. These parameters and the initial temperature of the food determined by an infrared (IR) sensor are fed into a thermal regression model. Pre-run thermal models are generated for a variety of selected foods to calculate various cooking times. The thermal regression model is used to calculate cooking time and cooking temperature. Once complete, the user can provide feedback on the cooked food, such as whether the food was cooked too much or too little. Such feedback is used to update a corresponding user profile to allow for a unique personal cooking experience. Over time, the system increases its adherence to user preferences to cook food more closely matching the user's preferences each time.

### BRIEF DESCRIPTION OF THE DRAWINGS

FIG. 1 is a schematic view illustrating an example use case environment for an embodiment of the cooking appliance and the cooking system.

FIG. 2 is an embodiment of a remote computing device illustrating possible components and program instructions.

FIG. 3 is an embodiment of the cooking appliance illustrating possible components of the cooking appliance.

FIG. 4 is an illustration of the field of vision (FoV) of a visible light camera in relation to an underlying cooking tray.

FIG. 5 is an illustration showing an arrangement of weight sensors for the cooking appliance.

FIG. 6 is an exemplary image data of a steak generated using an image mask, for use with a thermal model of the present disclosure to calculate cooking time and cooking temperature.

FIG. 7 illustrates how a food item being modeled can be divided into a plurality of horizontal layers to enable a thermal modeling algorithm of the present disclosure to model a temperature profile of the food item in a one-dimensional perspective using heat transfer equations.

FIG. 8 is a graph illustrating internal and external temperature curves for a food item, generated using a thermal modeling algorithm of the present disclosure.

FIG. 9 is an example user interface illustrating satisfaction criteria corresponding to a food item after cooking as a part of the user feedback.

FIG. 10 is a schematic depiction of some of the sensors sending data to the processor of either the cloud service or the cooking appliance and the processor sending or executing instructions for cooking a food item within the cooking appliance.

FIG. 11A is a schematic depiction of a process for creating and setting up a user profile with the cooking system of present disclosure to input predetermined user preference, which is collected by the cooking system as user food data for global and local user food preferences profiles generation.

FIG. 11B is a schematic depiction continued from FIG. 11A, illustrating operation of a cooking appliance of the cooking system to cook a food item after classifying the food item as a predicted food class and determining a cooking time and cooking temperature for the food item.

FIG. 11C is a schematic depiction continued from FIGS. 11A-11B, illustrating that after the cooking appliance cooks the food item at the cooking temperature for the cooking time, the cooking system notifies the user the food item is ready.

FIG. 11D is a schematic depiction continued from FIGS. 11A-11C, illustrating satisfaction criteria corresponding to a food item after cooking as a part of the user feedback and receiving user feedback for improving the cooking system performance.

FIG. 12 is a schematic illustrating an exemplary process for operating a cooking appliance to cook a food item according to the present disclosure.

FIG. 13 is an embodiment of the cooking system illustrating possible components of a computing system for the cooking system of present disclosure, which can be a cloud service or within the cooking appliance itself.

FIG. 14A is a schematic illustrating sensor fusion and fusion sensor conflict resolution after sensor inputs (data) from the visible light camera, the IR sensors, and the force transducers of the cooking appliance of present disclosure are received by the cooking system.

FIG. 14B is a schematic illustrating the application of uncertainty predictions using the predictive modeling after receiving the resultant data from sensor fusion depicted in FIG. 14A, to adaptively control cooking of the food item.

FIG. 15A is a schematic illustrating the use of a multi-zone/layer approach to generating a temperature profile of a food model for use with the thermal modeling algorithms of the present disclosure.

FIG. 15B is a schematic continued from FIG. 15A, illustrating the use implementation of a Physics-Informed Neural Network Architecture as the thermal model to predict food cooking time and temperature after receiving the sensor data from the food model illustrated in FIG. 15A.

FIG. 16 is a schematic illustrating how the cooking systems of the present disclosure may locally update thermal models and thermal modeling algorithms and then share those updates with a secure aggregation server for global thermal model and thermal model algorithm updates while protecting privacy of user data by processing data with privacy-preserving fleet intelligence.

FIG. 17 is a schematic illustrating location based automation process of the cooking appliance of current disclosure for detecting proximity of a user's phone through BLE or UWB.

FIG. 18 is an example schematic illustrating operative process of one or more motion sensors of a cooking appliance of present disclosure having one or more motorized doors.

FIG. 19 is a schematic illustrating a thermal management and a safety system for the cooking appliance of the present disclosure.

FIGS. 20A-B are together a schematic illustrating an exemplary thermal modeling process.

### DETAILED DESCRIPTION

As noted above, challenges exist in providing convenient and time-efficient meal preparation solutions. Current solutions can be expensive and inefficient and can produce less than satisfactory user experiences. For example, some solutions require multiple user interactions with the cooking device, inputs to the device (such as the type of food being cooked, type of cooking process, time and temperature settings, etc.), and/or user research to determine cooking parameters, such as cooking time and temperature. Some devices require a user to insert a temperature probe into the cooking item, thereby introducing additional inconvenience and opportunities for error, such as incorrectly inserting the probe.

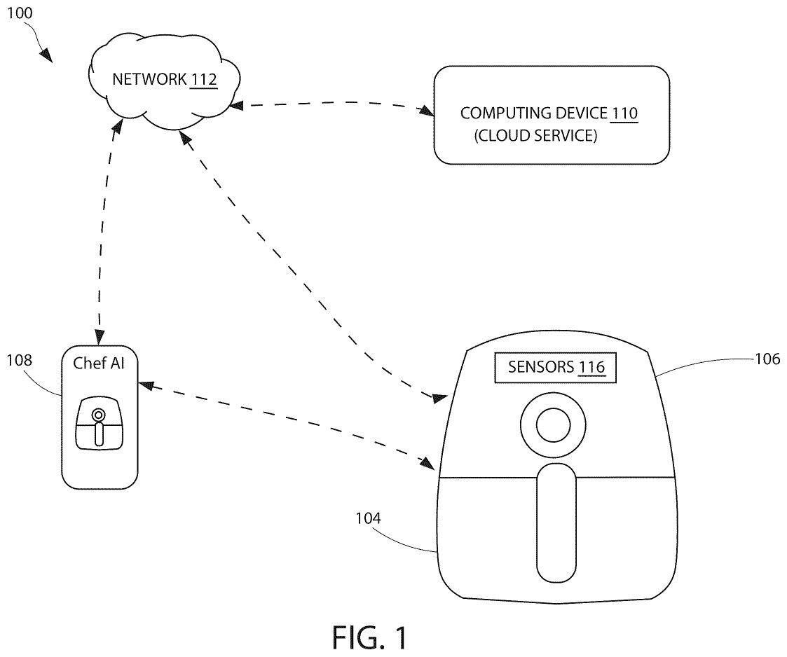

Accordingly, and as described in more detail below and in reference to FIGS. 1-20B, configurations of the present disclosure provide cooking appliances and cooking systems, and related methods for operating a cooking appliance to cook a food item that provide convenient and economical solutions for preparing quality food. In some examples of the present disclosure, a one-touch cooking process allows the user to simply place the food of their choice in the cooking appliance and provide a single input. Using parameters (image, weight, and starting temperature) determined by the appliance, the system, which can be the cooking appliance itself or include remote computing such as a cloud service, automatically cooks the food, including controlling temperature and duration of cooking, to the user's preference without any further intervention. By contrast, some other solutions advertised as “one-touch” do not truly allow for one-touch operation, since the user must choose between multiple input prompts before the food can be cooked.

In some examples, the system receives user feedback regarding a cooked food item and uses such feedback to programmatically train the system to adjust future cooking parameters to produce cooked items more closely matching a user's preferences over time. As described in more detail below, the present disclosure allows users to cook foods from meats to frozen items at a variety of starting temperatures. Advantageously, users are freed from any requirements to monitor food while cooking or guess when the cooking process is completed.

FIG. 1 shows a schematic view of an example use case environment in which one or more aspects of the present disclosure may be utilized. In the example system (also referred as the cooking system) 100 shown in FIG. 1 and as described further below, a cooking appliance 104 is communicatively coupled to one or more computing devices, such as a mobile phone 108 and a remote computing device 110, which could be a cloud service, via a network 112. Network 112 may take the form of a local area network (LAN), wide area network (WAN), wired network, wireless network, personal area network, Bluetooth network, ultrawideband (UWB) communication, or a combination thereof, and may include the Internet. It will be appreciated that in other examples, the cooking appliance 104, mobile phone 108, and/or remote computing device 110 may be communicatively coupled with additional computing devices.

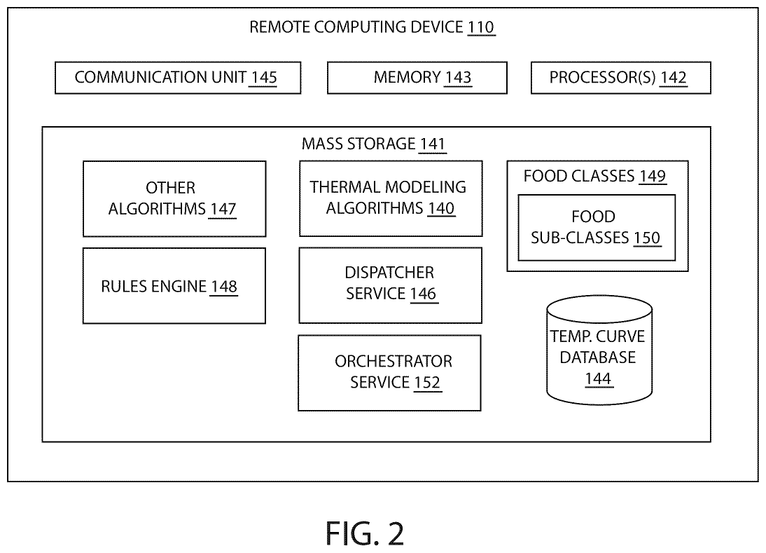

With reference to FIG. 2, remote computing device (such as a cloud service) 110 may be configured with program instructions according to examples of the present disclosure. Such program instructions may implement one or more of the methods and processes described in more detail below. In the example of FIG. 2 and as described further below, remote computing device 110 includes thermal modeling algorithms 140 that may be stored in a mass storage 141 of the remote computing device 110. Thermal modeling algorithms 140 and other algorithms 147 may be loaded into memory 143 and executed by a processor 142 of the remote computing device 110 to perform one or more of the methods and processes described in more detail below. The remote computing device 104 also has a communication unit 145 that communicates with the cooking appliance 104 and other devices such as a mobile phone 108 (see FIG. 1). In other examples, thermal modeling algorithms 140, other algorithms 147, and other program instructions and processing described herein can be stored in and executed by one or more processors of the cooking appliance 104, mobile phone 108, various combinations of the foregoing, and/or other computing devices.

For purposes of the present disclosure, the terms “thermal model” and “thermal modeling” describe the overall system and method for reliably determining the appropriate cooking time and temperature for an arbitrary food item placed into the cooking appliance 104. The thermal modeling algorithm 140 describes any algorithm that is used to determine or assist in determining the appropriate cooking time and temperature for an arbitrary food item placed into the cooking appliance 104. Therefore, the thermal model is also related to a user feedback system, which is described further below. To determine the best possible estimate of completion time for an arbitrary food item, precomputed values, knowledge-based systems, and statistical methods are combined in the thermal model. Thermal modeling algorithms 140 used by the thermal model of the system 100 can be, but not limited to, thermal modeling algorithms that are known in the art, predictive thermal modeling algorithm, inference algorithm, statistical methods or other algorithms for thermal modeling, machine learning algorithm, and regression modeling algorithm.

In some examples, time and temperature curves are generated using linear and polynomial regression techniques along with simulated or physical experiment data. Neural networks and their various permutations can also be used to implement regression techniques. Data gathered from any of the sensors 116 can be used as first-order inputs in the regression techniques. Data derived through the thermal modeling processes can be used as second-order inputs to the regression models. The thermal models can be processed and updated in both an online and offline manner.

Other algorithms 147 may be stored in the mass storage 114 of the remote computing device 110. Other algorithms 140 can be any algorithms that assist the thermal model of the system 100, such as, but not limited to, machine learning vision model algorithm for classifying image data of food items, food item classification models including machine learning models, a thresholding algorithm to determine what area in the image corresponds to the food item and what area in the image corresponds to the tray 132, and a gray-scale masking and blurring algorithm.

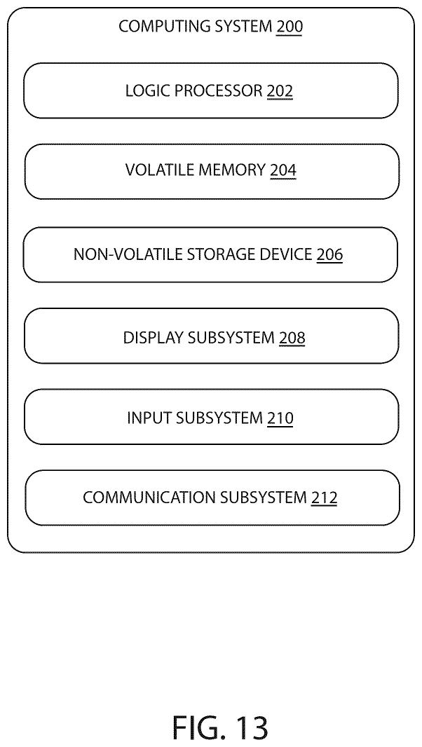

The remote computing device 110 may take the form of a network computing device such as a server, a cloud service, desktop computing device, mobile computing device such as a smartphone, laptop, notebook or tablet computer, or other suitable type of computing device. Additional details regarding the components and computing aspects of the remote computing device 110, mobile phone 108, and cooking appliance 104 are described in more detail below with reference to FIG. 13.

With reference again to FIG. 1, cooking appliance 104 comprises an enclosure (or a container) 106 and includes a plurality of sensors 116 located within or connected to the enclosure 106. Cooking appliance 104 collects sensor data from one or more of the sensors 116 and provides the sensor data to the remote computing device 110 and/or mobile phone 108 via a network 112.

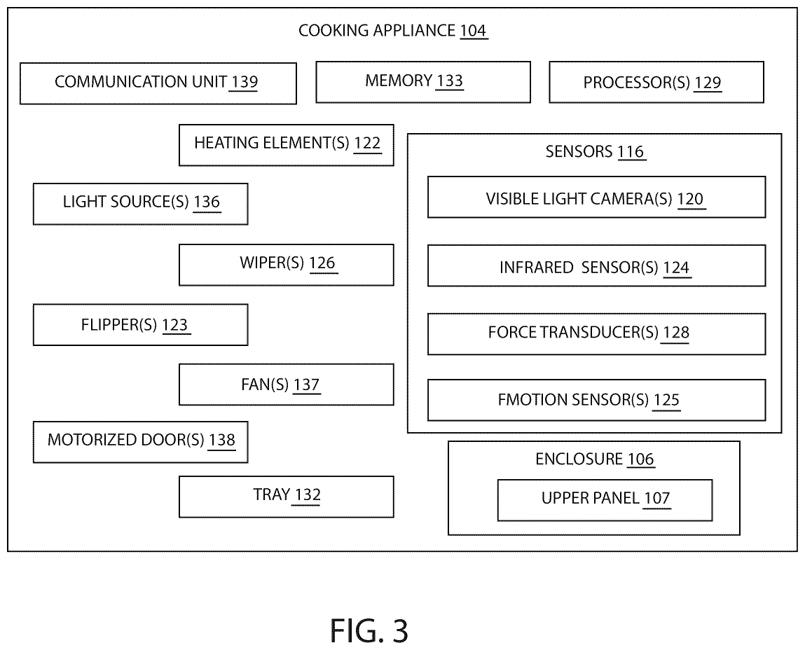

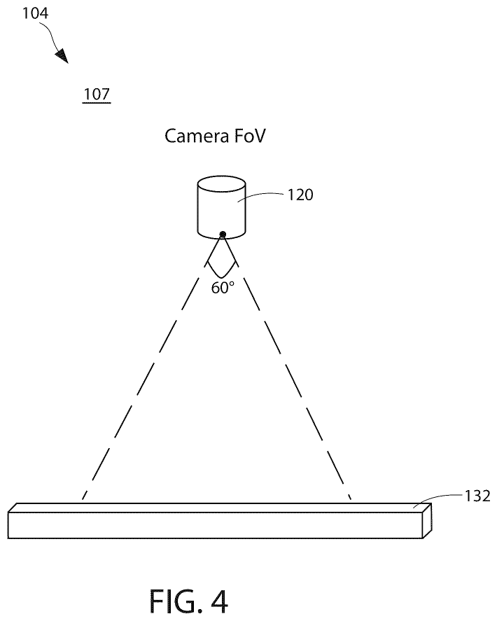

With reference to FIG. 3, in different examples, the sensors 116 in cooking appliance 104 can include one or more visible light cameras 120, one or more infrared (IR) sensors 124, and/or one or more force transducers 128 (and/or weight sensors). In one example, and as schematically shown in FIG. 4, a visible light camera 120 is mounted in an upper panel 107 in enclosure 106 and configured to capture image data of food items placed on an underlying tray 132 in the enclosure 106. As shown in FIG. 4, in one example, the visible light camera 120 has a field of view (FoV) of 60 degrees. In other examples, different fields of view can be utilized. Cooking appliance 104 also includes one or more processors 129, one or more memories 133, and a communication unit 139 that can communicate with remote computing devices 110 (see FIGS. 2, 13, 16), and other devices such as a mobile phone 108 (see FIG. 1).

In an embodiment, a clear, heat-resistant glass insulates the visible light camera 120 from the heat within the enclosure 106. The glass is insulated so that minimal heat passes through to the camera 120, and a small air buffer is created between the camera 120 and the glass.

In some examples, a clear, high-temperature ceramic glass is utilized, and the camera 120 is positioned to be as close as possible to the glass while still maintaining enough height to get a proper field of view that captures the entire area of interest, such as but not limited to, the underlying tray 132 (shown in FIG. 4) or food item on the underlying tray 132. In some examples, borosilicate glass can be utilized for the heat-resistant glass due to its 90% transmittance for visual light as well as its strong thermal properties. The camera 120 is positioned over the middle of the tray 132 to ensure the most compact FoV height while still capturing the entire tray 132 with food item. A heat-resistant and IR-compatible glass, such as potassium bromide (KBr) or silicone with an anti-reflection coating, can insulate the one or more IR sensors 124. The heat-resistant glass for the IR sensor 124 should allow for IR wavelength transmittance of the IR sensor 124 between 2-14 μm.

In some examples, two or more visible light cameras 120 are utilized within the enclosure 106. By utilizing two cameras 120 and leveraging stereo vision, depth analysis of the food item can be performed. By mounting the two cameras 120 at a fixed distance, the pixel displacement can be calculated. The two cameras 120 take images from different angles, thereby enabling the system to calculate the disparity/pixel offset between the images to assist with depth analysis. In this manner the depth/thickness of the food item can be determined. As described in more detail below, the depth/thickness of the food item can be provided to a thermal modeling algorithm 140 (shown in FIG. 2) that performs predictive analysis of cooking parameters for different food groups, where depth/thickness is a food item characteristic that impacts the duration and/or temperature of a cooking process.

With reference to FIG. 3, the cooking appliance 104 includes one or more heating elements 122 configured to heat food items within the enclosure 106. In different examples, the cooking appliance 104 can utilize a variety of different heating technologies known in the art that utilize different cooking techniques. Examples of heating technologies include, but are not limited to, convection cooking technologies, such as air fryers and convection ovens, microwave ovens, and cooktops utilizing gas, electric, inductive, or other cooking technology. In some examples, the cooking appliance 104 includes one or more fans 137 to control flow of heat and temperature. In some examples, the cooking appliance 104 includes a food item flipping mechanism (flipper) 123 that can selectively turn over a food item inside the enclosure 106.

In some examples, the cooking appliance 104 includes one or more light sources 136 that illuminate food items placed in the appliance 104 to assist the visible light camera(s) 120 in capturing accurate and stable images of the food items, to thereby enable accurate and reliable classification of the resulting image data. In some examples, the light is white to normalize the captured images under uniform conditions to match training images and sample training data. In some examples, a front-facing glass window on the cooking appliance 104 is tinted to absorb and reduce light from the outside. In some examples, grease splatter, steam, or other obstructive material could occlude the camera's 120 field of view. Accordingly, in some examples, the cooking appliance 104 includes a wiper system (wiper(s)) 126 comprising one or more wiper blades configured to wipe clean the heat-resistant glass that insulates the visible light camera 120. In some examples, the wipers 126 can be made from synthetic polyisoprene.

The sensors 116 include one or more IR sensors 124 configured to determine a surface temperature of a food item within the enclosure 106. This sensor data (the surface temperature of a food item) allows the system 100 to determine the starting external temperature of the food item. Advantageously, utilizing an IR sensor(s) 124 eliminates the need for a physical probe that must be handled and properly utilized with a food item by a user. As described further below, by determining the external temperature of the food item, the actual internal temperature of the food can be estimated. For example, a steak that is completely frozen is frozen on the inside as well. A steak that has been thawing may not be frozen on the outside but still frozen on the inside. Given that the exterior surface of the steak is slightly cooler than room temperature, the system 100 can infer the steak's internal temperature using statistical methods or other algorithms known in the art based on past cooks of steaks that have had the same or similar starting temperatures and/or other preconditions.

In reference again to FIG. 2, as described further below, the external temperature of the steak is provided to thermal modeling algorithms 140, which, given the type of food, select from a temperature curve database 144 a temperature curve that maps the food item to heating behavior. A smoothing algorithm is then applied, and the result is returned to a dispatcher service 146, which aggregates all the results/computations and returns the final time and temperature to the cooking appliance 104, which is controlled to cook the food item at the determined cooking temperature for the determined cooking time.

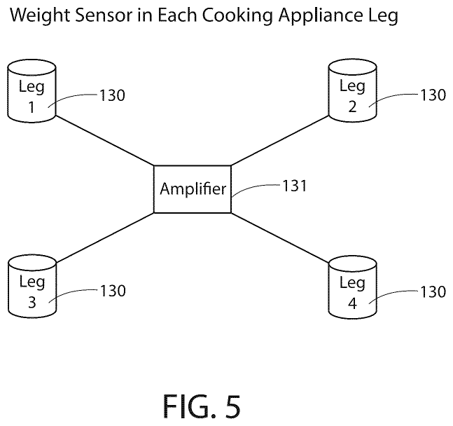

The cooking appliance 104 includes one or more force transducer(s) 128 to determine the weight of a food item. In one example and with reference to FIG. 5, a half-bridge strain gauge 130 is embodied in each of four legs of the cooking appliance 104 that support the appliance 104 on a surface. The half-bridge strain gauge 130 operates by transforming the mechanical force of the weight on the strain gauge 130 into an electrical “force.” This electrical force is determined by taking the place of the “missing” resistor of the bridge strain gauge system. These electrical signals (or data) are then sent to an onboard amplifier 131, which feeds the data back to an analog to digital converter (ADC) for processing. By placing these strain gauges 130, which in some examples can support up to 200 kg of mass, within the legs of the cookware appliance 104, the system 100 can determine the difference between the total mass of the appliance 104 with a food item and the total mass of the appliance 104 without a food item to estimate the mass of the food item with high precision and accuracy. In some examples for food items ranging in mass up to approximately 2.5 kg, the cooking appliance 104 can estimate the weight of a food item within a range of +/−5% variance. One potential advantage of this configuration is that half-bridge strain gauges 130 utilized in this manner are not subjected to high temperatures produced in the enclosure 106, and thus do not require thermal insulation.

In other examples, the cookware appliance 104 can utilize one or more load cell amplifiers within the enclosure 106, such as under tray 132, that support up to 20 kg and can be capable of higher precision measurements. The load cell amplifier(s) are insulated, such as with ceramic fiber, to protect load cell components from deformation and potentially distorted data. The load cell can be housed in an encapsulation enclosure that includes a plate that supports the tray 132.

For food items containing water, data from the force transducer(s) 128 can be utilized to estimate the doneness of the food item by determining the amount of weight lost by the item during cooking. As certain types of foods cook, they dehydrate and lose water. This loss in moisture can be correlated to a certain doneness of the food. In some examples, experiments utilizing pre-cook weight measurements and post-cook weight measurements with different food items cooked for different cooking times can be performed. The cooking times and weight measurements can be input into a linear regression model to predict the cook time for a particular food item based on these measured experiments.

In some examples, the cooking appliance 104 can contain condensation prevention features to prevent issues from moisture and steam. The interior glass surfaces can contain anti-fog coatings. The system 100 can contain thermal gradient management to keep glass above a dew point. Furthermore, a vision algorithm and other algorithms can be used to detect presence and/or amount of moisture covering the glass. The cooking appliance 104 can contain micro-perforations for pressure equalization. Additionally, hydrophobic treatments can be applied to the optical surfaces to prevent moisture-based optical issues.

Data from the IR sensor(s) 124 also enables the system 100 to immediately stop the cooking process by turning off the heating elements 122 and/or other components once the food item has reached a certain threshold temperature based on its classification. By feeding the food item's classification to the thermal modeling algorithms 140, the system 100 can determine the minimum and maximum acceptable temperature for a food item, along with its actual external temperature and estimated internal temperature. Leveraging both of these as well as other inputs collected during the cooking process by the visible light camera(s) 120 and force transducer(s) 128, a weighted decision algorithm is utilized to prevent food from being overcooked and to avoid damage to the cooking appliance 104 and its various components from overheating.

In some examples, cooking appliance 104 can be configured to automatically reheat a food item that has been left in the appliance 104. In some examples, the system 100 measures the time since the appliance 104 was last opened and/or closed. In one example, based at least in part on the time since the appliance 104 was last opened (e.g., comparing such time to a predetermined time threshold) and based on the proximity to the cooking appliance 104 of a computing device associated with the user and/or the cooking appliance 104, such as mobile phone 108, the system 100 causes the cooking appliance 104 to automatically reheat the food item. Each type of food has a characteristic protein or starch breakdown temperature threshold. Accordingly, in these examples, one or more of the same thermal modeling algorithms 140 that are used to determine cooking times and cooking temperatures for refrigerated or frozen food items can be trained to determine cooking times and cooking temperatures for reheating food items that have been previously cooked.

In some examples, the cooking appliance 104 includes a single IR sensor 124 which points to an area in the center of the tray 132. In other examples, two or more IR sensors 124 can scan a predetermined area of the tray 132. The IR sensors 124 create a heat map that covers the area covered by the cameras' 120 FoV. In some examples, as a precondition to starting to cook a food item, the cooking appliance 104 is configured to determine if a food item is located in the area covered by the cameras' 120 FoV. On condition that the system 100 determines that the food item is located in this area, the cooking appliance 104 can proceed with cooking the food item.

In some examples, two algorithms 140, 147 can be utilized, separately or in combination, to determine the temperature of the food prior to cooking, during a cooking process, and/or after a completed cooking process:
1. Determine the average value of the n×n pixel array that the IR sensor(s) 124 output. Based on this average value, sampled over a time t for denoising, use this average value as the input to set the initial time and temperature and to stream to the temperature graph.
2. Determine the minimum temperature value within the n×n pixel array and use that as the input value. This is to handle cases in which the food isn't properly centered or the n×n array doesn't capture all the food.

In other examples, the one or more IR sensors 124 are moveable cameras 124 that include a gyroscope. In these examples and utilizing information from the visible light camera(s) 120, the IR sensors 124 can scan the tray 132 at the determined location of the food item and determine an average of the sample of temperature measurements of the food item.

The vision system of the present disclosure enables the accurate recognition and classification of food items for an extremely diverse set of food types spanning a wide variety of food items that can be cooked in a cooking appliance 104. The food items span meats, carbohydrates, and vegetables, and may also include more complex food items with a mixture of different kinds of macronutrients. New foods can be added to the system 100 (using an over-the-air (OTA) update system) by following a process of review based on a ruleset of what foods are capable of being cooked in the particular cooking appliance 104, and subjective determinations regarding whether the cooking appliance 104 would be capable of cooking the food item in a satisfactory manner. This includes training a new class of food items for image identifier models, as well as thermally modeling and performing manual investigations into accurate initializations for different starting configurations of a food item.

As image data from the visible light camera(s) 120 is collected, the system 100 uses this image data to refine and improve its classification models. Features such as food item type classification, length, width, approximate height, estimated pose, and inferences of existing food object(s) that are blocked from image capture due to obstruction are extracted and utilized to train machine learning models and to classify a food item into one of a plurality of food classes 149 (shown in FIG. 2) and food subclasses 150 (shown in FIG. 2).

The following two example use cases illustrate aspects of the vision pipeline of the current disclosure. In these examples, a single visible image camera 120 and single IR sensor 124 are utilized. The first example use case includes a steak food item. The steak is placed on the tray 132 and under the visible light camera 120 and the IR sensor 124. Using at least image data from the visible light camera 120, the steak is classified first as “Meat” food class 149 and then as “beef” food sub-class 150 and finally as “steak” food sub-class 150 under a hierarchical routing model, which can also process categories such as pork, lamb, chicken, and fish.

For food items that are determined to fall under “Meat,” the system 100 determines the thickness of the food item, which is used as an input in determining how long food needs to be cooked to be safe to eat and cooked to the user's preference. In one example, the metric of completion of the cooking process is the internal temperature of the food item, denoted as yy. In some examples, the internal temperature is the internal temperature at the approximate center of the food item.

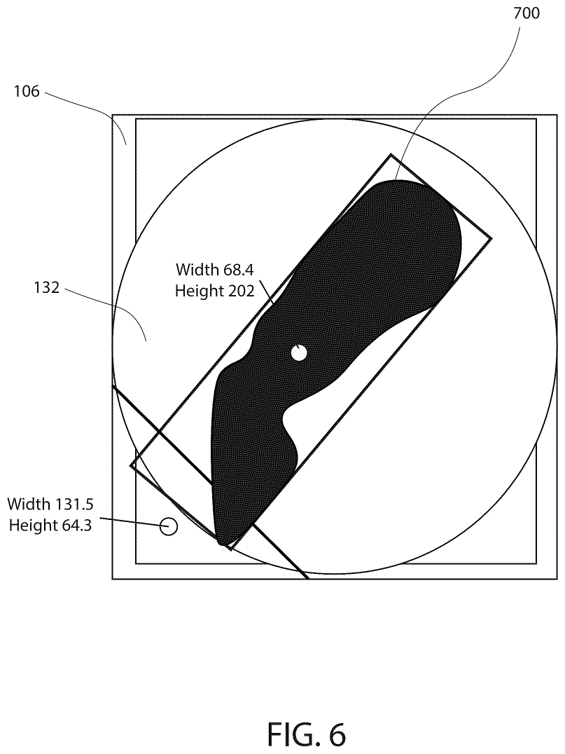

Because the height of the visible light camera 120 is fixed and the total area of the tray 132 is known, the area of the tray 132 covered by the food item can be approximated by applying an image mask in colors to the meat and tray differently with significant contrast. In one example, the tray 132 is painted with a black, non-reflective coating at least where the food item will sit. This allows for maximum contrast and limits any interference/reflections from external lights. The RGB values of the pixels captured by the visible light camera 120 are processed by a thresholding algorithm to determine what area in the image corresponds to the food item and what area in the image corresponds to the tray 132. A gray-scale masking and blurring algorithm is then performed to produce a vivid contrast between the food item and the tray 132. An example of an image of a steak 700 on a tray 132 within the enclosure 106 of the cooking appliance 104 generated using an image mask is shown in FIG. 6.

Also, in this example, the mass of the food item is determined from the force transducer(s) 128, and the density of the food item is retrieved using the determined food classification, such as from a lookup table. By performing these steps and then performing a pixel count of white pixels and black pixels, the approximate volume of the food item can be determined using the formula p=m/V, or density equals mass over volume.

The next example use case includes a food item of French fries. The fries are placed on the tray 132 and under the visible light camera 120 and the IR sensor 124. Using at least image data from the visible light camera 120, the food item is classified first as “Carbohydrates” food class 149, then as “Fries,” food sub-class 150 and finally as the type of fries (food sub-class) 150, such as thinner shoestring fries or thicker fries like steak fries. For classifications that fall under carbohydrates, the system 100 does not calculate the thickness of the food item and can use only weight as an inputted food characteristic. A Kalman filter is utilized to interpolate the cooking time based on which classification the fries fall under. The adjustments to the statistical model are then back propagated from the storage of experimental results, which are used to improve the models for the next cooking session.

In some examples, the system 100 determines that a food does not fall into an existing classification, and the food item is assigned to a “Not supported” category. The “Not supported” category is trained using a garbage class of data. As more food items are added to this category, a versioning technique is performed that minimizes performance degradation while optimizing for classification accuracy and precision of the food items.

In some examples, images of a food item are captured during a cooking session at discrete time steps and are provided to the thermal modeling algorithms 140, including machine learning algorithms. To maximize the impact of this data while minimizing the data overhead, the image is compressed and decoded at the remote computing device 110 so that the data transmission is as efficient as possible over the network 112. To minimize latency impacts, the corresponding results can be asynchronously processed, and the cooking session is updated when all the processing is complete and aggregated.

For purposes of the present disclosure, the terms “thermal model” and “thermal modeling” describe the overall system and method for reliably determining the appropriate cooking time and temperature for an arbitrary food item placed into the cooking appliance 104. The thermal modeling algorithm 140 describes any algorithm that is used to determine or assist in determining the appropriate cooking time and temperature for an arbitrary food item placed into the cooking appliance 104. The thermal model is also related to a user feedback system, which is described further below. To determine the best possible estimate of completion time for an arbitrary food item, precomputed values, knowledge-based systems, and statistical methods are combined in the thermal model.

While instructions exist describing how to cook many food items, often the food item is not labeled with these instructions, and a user is forced to research or use their own intuition to determine an appropriate cooking time and temperature, and often to frequently monitor and intervene in the cooking process. Producers of food sometimes provide recommendations for how long and at what temperature to cook the food based on experiments run at an industrial scale with taste testers who ultimately determine which configuration of cooking parameters leads to the best taste and texture for the consumer. Information of this type is collected from a variety of foods and food producers and utilized in an inference algorithm of the thermal model, which determines a serving amount by counting the number of pieces of the food item, combining the serving amount with the determined weight of the food item, and using a precomputed temperature/time curve for that specific food group. This method assumes that temperature stays constant and time increases somewhat linearly as additional mass is added.

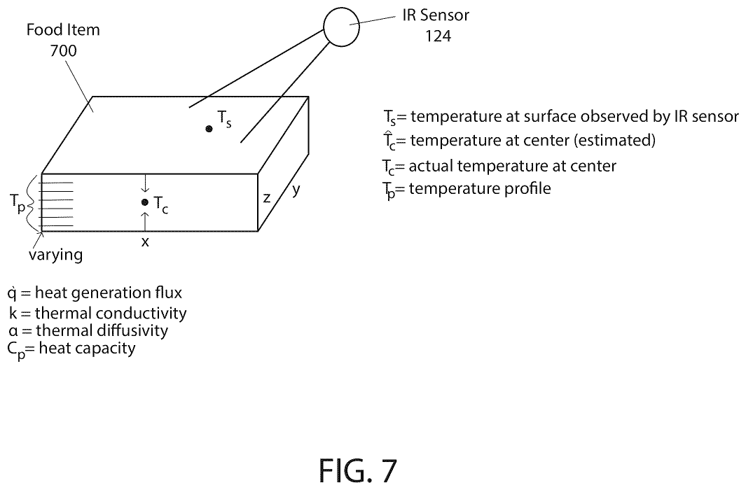

In some examples, determining the time and temperature of cooking a food item can additionally or alternatively include modeling a temperature profile of an arbitrary food item in a one-dimensional perspective using heat transfer equations. In these examples and with reference to FIG. 7, the food item 700 being modeled is divided into a plurality of horizontal layers, where each layer can have different macronutrient composition and different thermal properties like crust formation. Properties such as thermal conductivity k, thermal diffusivity α, and heat flux φ̅_{q} are all food item properties that can vary with time. Based on the form factor of the cooking appliance 104, certain properties about the overall system 100, such as heat generation rate, convection coefficient, and pressure, are predetermined. In some examples, this model is used with food items that are uniform in height or can be assumed to be uniform in height, such as pieces of meat, breaded items, and other flat items. If a food item is highly nonuniform and has a significantly different composition from top to bottom that cannot be divided into fairly uniform-composition horizontal layers, like broccoli with cheese, this model can be utilized with assumptions corresponding to the particular food item, and may be weighted less heavily in the final result.

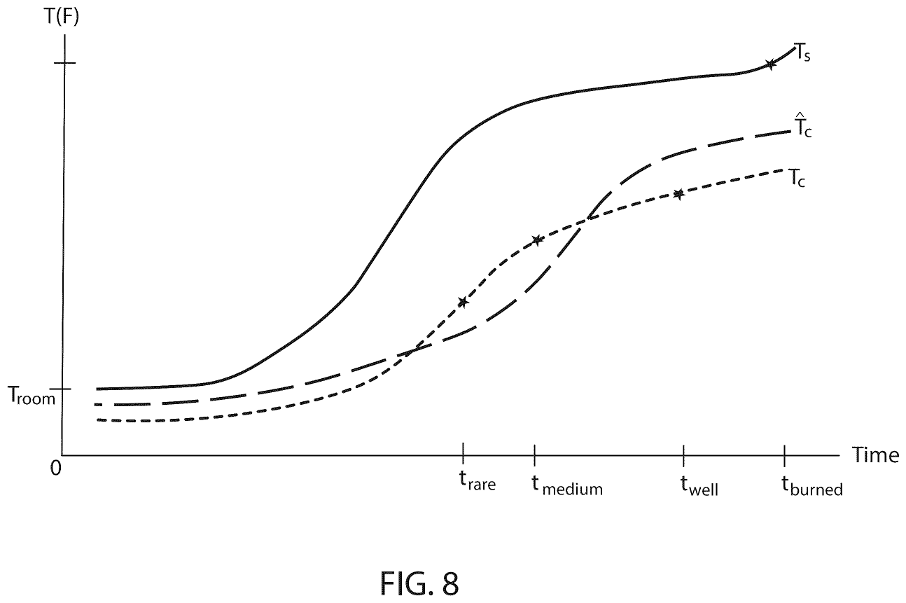

As noted above, the system 100 can estimate the internal temperature of a food item using the external surface temperature of the food item that is measured using the IR sensor(s) 124. With reference to FIG. 8, examples of internal and external temperature curves for a food item of steak that are generated using a thermal model of the present disclosure are illustrated. Along the x-axis is the cooking time, with the times corresponding to a rare preparation, medium preparation, well-done preparation, and burned preparation indicated. In some examples, the internal temperature of the food item is computed using the following equation:

$$\frac{{d}^{2} T ( x )}{{dx}^{2}} + \frac{q}{k} = \frac{1}{α} \cdot \frac{dT ( x )}{dt}$$

Integrating twice produces T(x), the temperature profile at each height (layer) in the food item.

Using the results of actual physical cooking experiments, the estimated center temperature and actual center temperature of a given food item are resolved to converge these temperatures to be as close as possible. Different initialization techniques are utilized, and computational methods are utilized to interpolate the curves for different parameter configurations and different food items.

Additionally, or alternatively to the above methods, methods utilizing computational fluid dynamics (CFD) can be utilized to model the internal temperature of different food items, where such food items have been previously cooked under controlled conditions. Each cooking appliance 104 has a different form factor and capabilities, which influence how heat is distributed in the cooking appliance 104. The cooking appliance 104 is modeled using the exact dimensions of the appliance 104 and heating performance criteria, such as rotation speed on the fan 137, power on the heating element(s) 122, etc. Using the modeled geometry of the cooking appliance 104 device, a meshing algorithm is run that converts each part of the device 104 into 3D cubes. These cubes are then processed by CFD algorithms that include libraries or solvers that utilize differential equations for turbulent airflow and other appropriate thermal heating use cases. The thermal properties of the particular components of a cooking appliance 104, such as the heating coil, heat outlet/exhaust, and air inflow/inlet, are set as constants. The variables are the thermal properties of the food item, such as thermal conductivity, specific heat, density, etc.

A simulation is performed using the CFD algorithms and a predetermined time step. In some examples, the time step is selected to provide accurate results while also reducing the required computational resources. Once the food item reaches its target internal temperature, the simulation is halted. These simulations can be run in containers in a cloud service 110 (shown in FIG. 2) in the remote computing device 110 for parallelization and used to build out temperature curves for different groups of food. In some examples, all foods classified in the same category are assumed to exhibit the same thermal behavior. For example, all foods classified as meat>beef in the system's hierarchical model can be assumed to exhibit the same thermal behavior. In these examples, computational resources can be preserved by refraining from adding additional logic for specific compositions, such as differentiating a flank steak that is leaner than a ribeye steak. In some examples for food items that do not require achieving precise internal temperatures, the system 100 may refrain from using this CFD model and instead use other mechanisms to determine the appropriate cooking time and temperature.

The thermal models of the present disclosure can utilize statistical models and machine learning technologies. Therefore, thermal modeling algorithms that are used for these thermal models of the present disclosure can be statistical algorithms, machine learning algorithms, artificial intelligence algorithms, or any other algorithms known in the art. In some examples, time and temperature curves are generated using linear and polynomial regression techniques along with simulated or physical experiment data. Neural networks and their various permutations can also be used to implement regression techniques. Data gathered from any of the sensors 116 can be used as first-order inputs in the regression techniques. Data derived through the thermal modeling processes can be used as second-order inputs to the regression models. The models can be processed and updated in both an online and offline manner.

In some examples, Kalman filters are utilized to protect against noisy readings from sensors 116. Using knowledge of prior surface temperatures, inferences of new surface temperatures are made. Predictions are made and then updated using the actual surface temperature measurements. These processes also enable tracking the variance/uncertainty of the estimates and allow the system 100 to dynamically adjust the cooking time during the cooking process as new sensor readings are received. In this manner, new predicted times can be computed using only the previous state and a covariance/uncertainty matrix. In combination with the system's 100 internal temperature inference algorithms, the internal temperature of foods can be estimated with an acceptable degree of certainty.

In some examples, a labeling system is utilized that classifies and evaluates each food item along six different dimensions (food classes 149 and/or food sub-classes 150):
1. Primary Food Group—Meat, Grain, Vegetable, Fruit, Meat, Dairy;
2. Valid Cooking Methods—Optimized for frying, baking, grilling, roasting, sauteing, broiling, etc.;
3. Composition—Percentage of each macronutrient of which a food item is composed;
4. Structure—Solid, Semi-Solid, Liquid;
5. Ingredients—Primary basic ingredients of which a food item is composed;
6. Cuisine—American, Chinese, Indian. Italian, etc.

Based on the determined classification of a food item during image capture, different functions are run to determine the time and temperature of the cooking process. In some examples, a rules engine 148 (shown in FIG. 2) determines which functions can be run for certain food items to determine the estimated cooking time and temperature for a food item. For example, steak is meat with a primarily protein and fat-based composition, and can be air-fried or grilled. On the initialization of a cooking session, the relevant observed and inferred properties are dispatched to the appropriate regression models of the thermal modeling algorithms 140. Predetermined rules can be applied to the results by the thermal model curves. For example, an absolute minimum of 7 minutes cooking time on a 10 oz steak and an absolute maximum of 14 minutes cooking time for the 10 oz steak is applied to prevent undercooking or overcooking. The computations are done in parallel and returned to an orchestrator service 152, which aggregates and weights the results based on trust scores and feedback from local and global user preferences of the cooking appliance 104. The recommended cooking method, time, and temperature are then automatically set for the user.

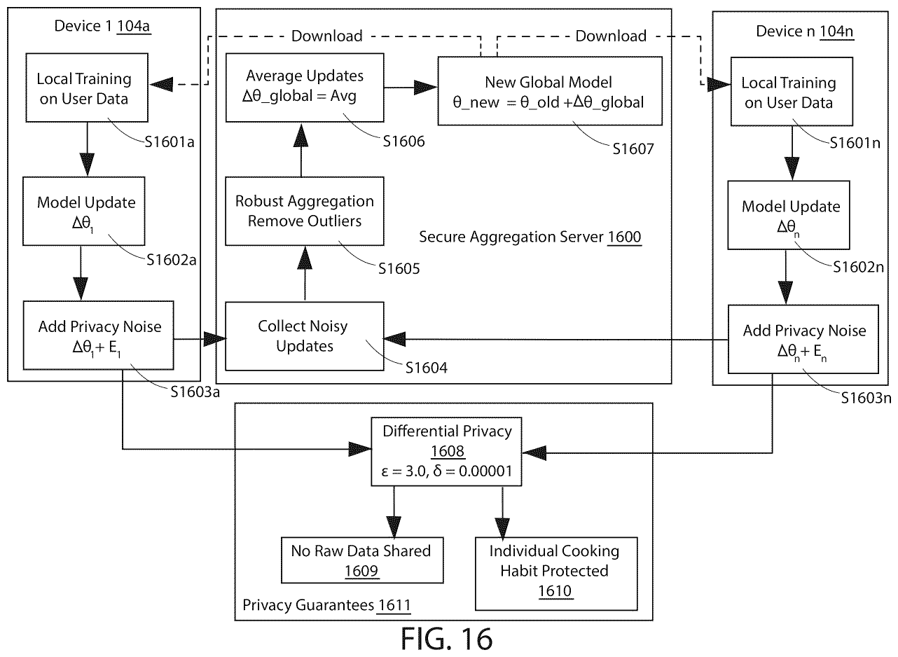

In some examples, to maintain model performance on existing food items while allowing for extensibility to new foods to be onboarded to the system 100, a decoupling architecture is utilized, which has separate models for each food group (food classes 149) and also separate models for specific food items. Logging and observability techniques are utilized to monitor a fleet of cooking appliances 104 (see FIG. 16). Thermal modeling algorithms 140 and temperature curves can be updated in an online manner and provide over the air (OTA) updates to cooking appliances 104 in real time. In some examples, offline evaluation of observability metrics can be performed and used in conjunction with user feedback to process and update models in an offline manner with a stable release pattern. The canary release can be used as a way to A/B test old and new deployments of models before ultimately deciding to update or roll back new changes. In some examples, most processing is offloaded to the remote computing device 110 and corresponding cloud services 153, while minimal computational resources are utilized on processor(s) 129 of the cooking appliance 104 and/or mobile phone 108.

In some examples, each sensor 116 type has complementary sensor capabilities to one another to detect phenomena that are undetectable with one sensor 116 alone. Visual sensor 120 and infrared sensor 124 fusion can be used to detect unique phenomena, such as steam pockets, uneven thawing, crust formation, etc. Infrared sensor 124 and weight sensor (force transducer) 128 fusion can be used to detect unique phenomena, such as ice melting, moisture evaporation, fat rendering, etc. Visual sensor 120 and weight sensor 128 fusion can be used to detect unique phenomena, such as bread rising, vegetable wilting, meat shrinkage, etc. Additional fusion combinations can be created for desired data collection based on the physical characteristics detected by each sensor 116 type.

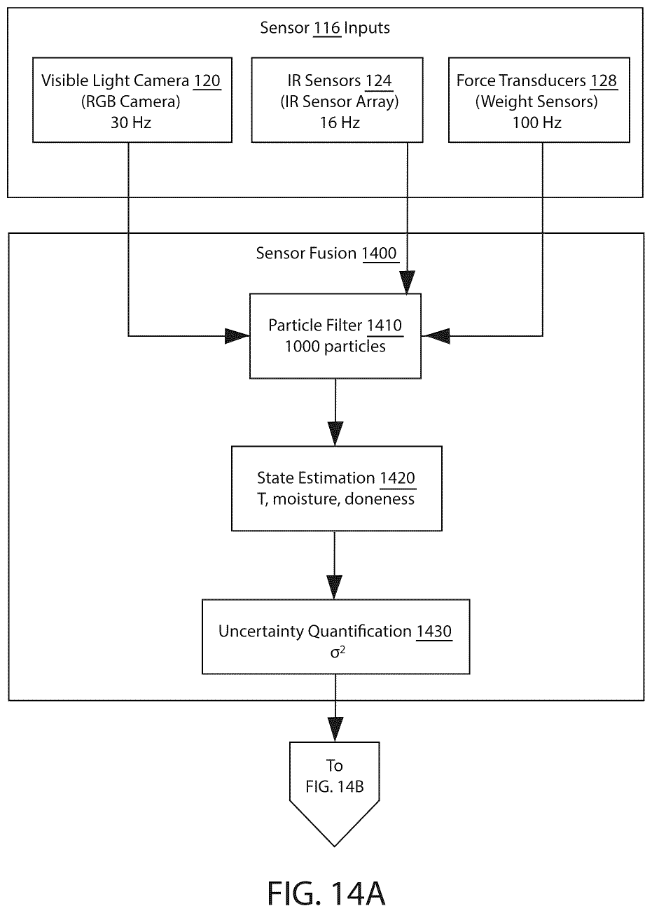

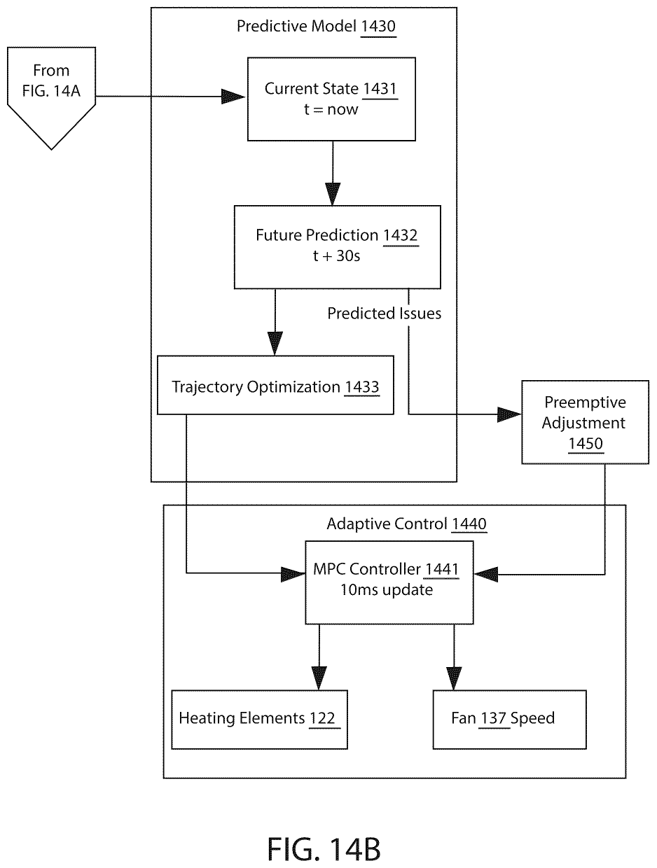

In some examples, and as shown in FIGS. 14A-14B, the system 100 can employ probabilistic sensor fusion 1400 to create a unified cooking environment model from multiple uncertain sensor 116 inputs. Unlike existing systems that use simple weighted averaging, this approach maintains uncertainty estimates for each sensor 116 and intelligently resolves conflicts. Each sensor 116 provides not just a measurement data, but an uncertainty estimate data with full probability distributions using known techniques, such as Bayesian statistics. The system 100 can maintain particle filters 1410 with 1000 particles representing possible food states, updated at a certain frequency, such as 10 Hz, using known methods, such as the Sequential Monte Carlo method. Each particle in the particle filters 1410 could represent a hypothesis about the food's current state, or state estimation 1420, such as but not limited to temperature distribution, doneness level, moisture content, etc. As sensor 116 data arrives, particle weights can be updated based on how well each hypothesis explains the observations, with resampling to focus computational resources on likely states.

In some examples, the system 100 can use conflict resolution methods when sensors 116 disagree. The system 100 can use confidence-weighted fusion 1400 with dynamic reliability scoring. These weights can adapt based on historical accuracy.

As shown in FIG. 14A, the particle filter 1410 fuses data from the visual light cameras 120, IR sensors 124, and weight sensors 128 to estimate not just the food's current state (temperature, moisture, doneness) but also the confidence level (62) in those estimates as uncertainty quantification 1430. As shown in FIG. 14B, the uncertainty quantified estimates are then used by the predictive model 1430 for predictive control. The system 100 projects cooking trajectories 30 seconds forward as future prediction 1432 and identifies potential issues before they occur (i.e. overcooking of certain food zones). The system 100 then optimizes adjustments to the cooking appliance 104 components such as the heating elements 122 and fan 137 through trajectory optimization 1433, and implements those preemptive adjustments 1450 via a model predictive control (MPC) controller 1441 that updates every 10 ms for adaptive control 1440. The number of seconds and milliseconds given are examples and the times can be adjusted as needed. Physics-informed predictive approach as shown in FIGS. 14A-14B allows prevention of problems preemptively instead of reacting once problems occur, thereby allowing the system 100 to continuously adapt as new sensor data refines the outcomes of the predictive model 1430.

The system 100 can use multi-zone 720 approach with the thermal modeling algorithm 140 to create physics-informed adaptive learning. The system 100 can combine machine learning with known physics to ensure predictions with respect to laws of physics with adaptations based on real-world variations. Instead of only using complex 3D heat diffusion equations, the system 100 can employ a hybrid approach that balances accuracy with computational efficiency.

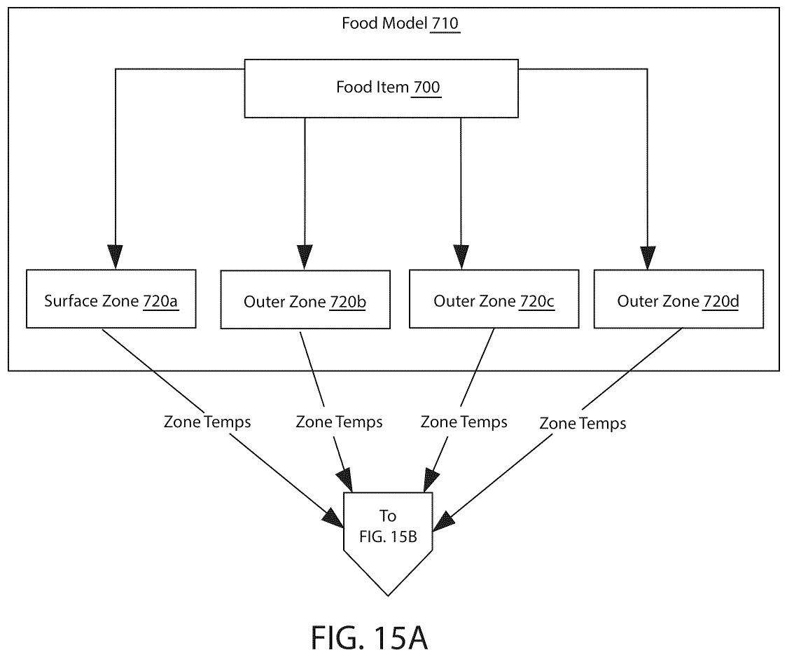

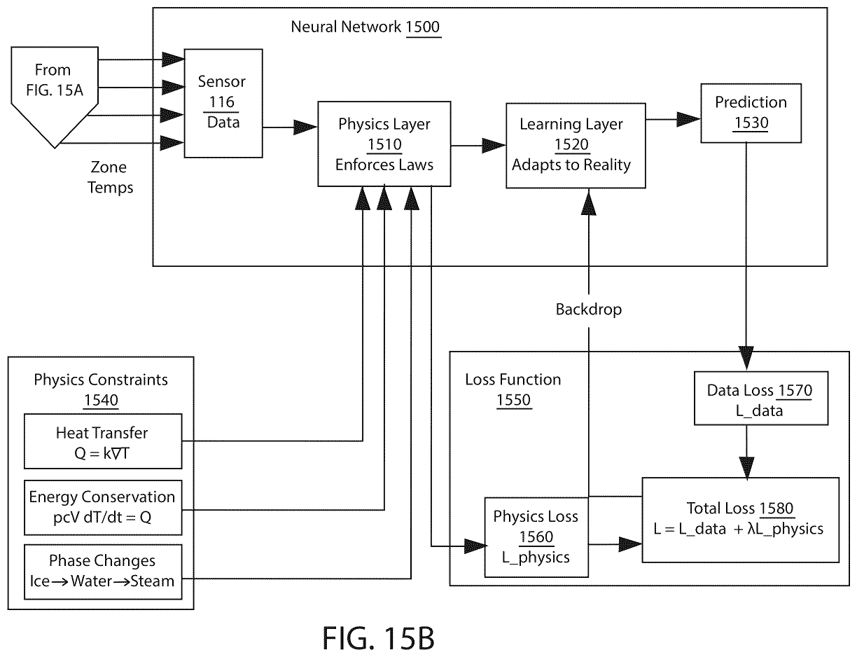

For example, FIGS. 15A-15B shows a food model 710 that divides the food item 700 into multiple zones 720a-720d to calculate zone temperature for each zone, which is used as sensor 116 input data for neural network 1500 (as the thermal modeling algorithm 140). The neural network 140 shown in FIG. 15B, which could be a Physics-Informed Neural Network Architecture (PINN), with physics layer 1510 and learning layer 1520, to enforce physical constraints 1540 through a specialized loss function 1550 in learning and generating its prediction 1530. Physics constraints 1540 (heat transfer, energy conservation, phase changes, etc.) ensure that heat flow follows thermodynamic laws even when extrapolating beyond training data. This enables accurate predictions 1530 for novel food items. The loss function 1550 takes into account of physics loss 1560 as well as data loss 1570 from prediction 1530 to calculate the total loss 1580, to be used as the backpropagation for the learning layer 1520 to enable the learning layer 1520 to adapt to reality.

In some examples, the system 100 can use a data-efficient learning strategy. Recognizing the challenge of limited initial data, the system 100 can employ a progressive learning approach where the system 100 begins with pure physics-based models using documented thermal properties, then combines physics models with neural corrections as data accumulates, and finally, the neural network 140 learns correction factors.

In some examples, the system 100 dynamically estimates and compensates for emissivity changes during cooking. Different foods and cooking states emit infrared radiation differently. This is critical for precision cooking, where a 1.5° C. error can mean the difference between rare (130° F.) and medium-rare (135° F.) steak since these cooking states are separated by only 5° F. The system 100 can use continuous calibration to maintain a differentiable emissivity model that gets updated in real-time. Cameras 120 and other sensors 116 can capture visual features correlated with emissivity through a neural network or other computer system. The data can obtain relevant emissivity indicators, such as surface color, texture analysis, moisture indicators, browning progression, etc.

In some examples, the system 100 can use spatial emissivity mapping to improve accurate temperature measurements across food items 700 with varied toppings, ingredients, or distinct crust and crumb regions. For heterogeneous foods, the system 100 can generate emissivity maps using superpixel segmentation. Each superpixel can be put into classifications, such as protein, carbohydrate, fat, moisture, etc. Emissivity values can be interpolated from learned class profiles. Bilinear upsampling can also be used to match resolutions.

In some examples, the system 100 can use time-series anomaly detection to detect anomalies, such as temperature changes outside of predicted ranges, sudden weight drops, stagnation, etc. The system 100 can maintain separate anomaly models for different food items, such as proteins, starches, and vegetables, each trained on category-specific failure modes.

With reference to FIG. 16, the system 100 can connect with the fleet of cooking appliances (or devices) 104a, 104n that has its own respective local copy of the thermal model or any other models that are being used by the system 100 such as a vision-learning model, that train on the respective user data as shown in steps S1601a, S1601n. The fleet of cooking appliances 104a, 104n updates its respective local thermal model and any other models using local user data in steps S1602a, S1602n, which are then shared to a secure aggregation server 1600 (which can be a remote computing device 114 as previously discussed) to improve global thermal model or any other global model at step S1607. Therefore, when the system 100 is connected to the fleet of cooking appliances 104a-104n, similar or not, the system 100 can maintain a local thermal model or any other model for user preferences.

Privacy noise is added at steps S1603a, S1603n to the local user data before they are shared to the secure aggregation server 1600 and collected as noisy updates at step S1604. The system 100 can use any methods known in the art for data privacy protection, such as calibrated Gaussian noise. Robust aggregation can be used to remove outliers in data at step S1605 before average updates are done at step S1606. Global thermal model and other global model updates from step S1606 produces the new global thermal model and other global models shown in step S1607, which are then downloaded by the fleet of cooking appliances 104a, 104n to update the local thermal model and other local models. Privacy guarantees 1611 are made by using differential privacy 1608 when the privacy noises are added at step S1604a, S1605n, which results in no raw data being shared 1609 and individual cooking habits protected 1610. Thus, the system 100 protects privacy of user data by processing data with privacy-preserving fleet intelligence.

In some examples, when the confidence of the local primary neural network drops below a certain threshold, the system 100 can engage the cloud-based vision-language models.

The system 100 can contain safety monitoring systems to prevent system damage from heat, moisture, and other cooking or electronic related conditions. Glass can contain sensors 121 to ensure proper optical properties are maintained. Camera module temperature can be used to prevent damage to electrical components and CMOS (Complementary Metal-Oxide-Semiconductor) degradation. Ambient zone monitoring can be used to help protect supporting electronics. Predictive thermal modeling algorithms 140 can also be used to anticipate temperature rises.

Components can additionally be protected through thermal isolation, heat sinking, conformal coating, and temperature derating. Components may be mounted on thermally isolated PCB sections. Critical components can be connected to exterior heat dissipation devices to prevent damage from high temperatures through heat sinking. Conformal coatings protect the components from moisture and thermal cycling. Components may also operate near a 60% maximum temperature rating.

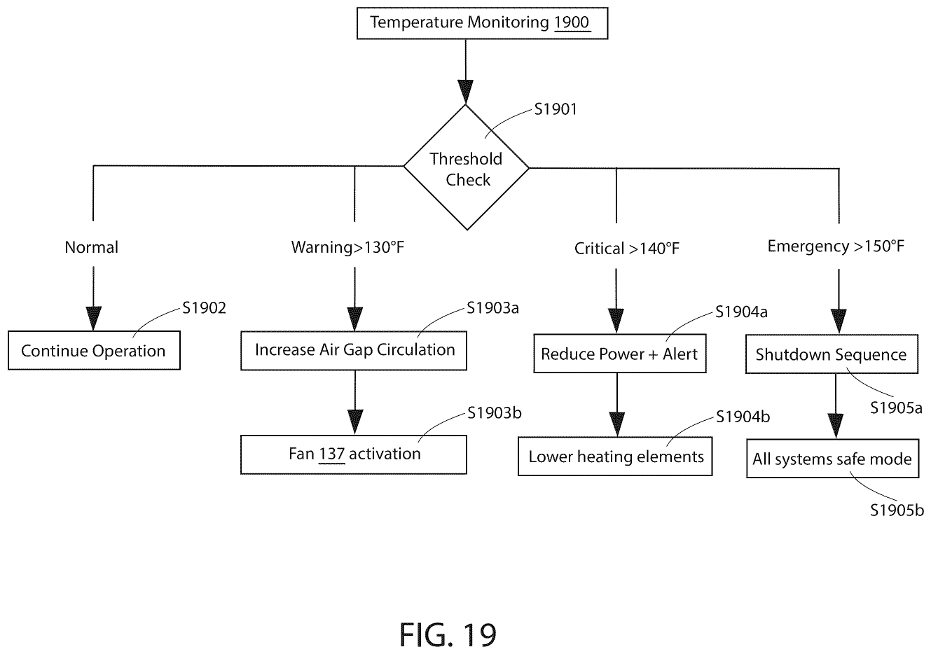

FIG. 19 gives one example of such safety system for temperature monitoring 1900. The system 100 conducts temperature threshold check at step S1901. If the temperature is normal, the system 100 continues the cooking operation at step S1902. If the temperature is greater than 130° F., the system 100 enters a warning mode and increases air gap circulation in step S1903a-b by activating one or more fans 137 of the cooking appliance 104. If the temperature is greater than 140° F., the system 100 enters a critical mode and reduces power and alerts the user in step S1904a-b by lowering the heating elements 122 of the cooking appliance 104 and alerting the user through sound and/or visual indications. If the temperature is greater than 150° F., the system 100 enters an emergency mode and shuts down the sequence, and therefore the cooking appliance 104, in step S1905a-b by entering all systems safe mode.

It will be appreciated that in different examples, all of the above-described methods and processes can be utilized together to produce cooking times and temperatures for food items. In other examples, one of the above-described methods can be utilized or a selection of these methods can be combined to produce cooking times and temperatures for food items. In different use case scenarios, results produced by different methods/models can be weighted differently in determining a final cooking time and temperature.

In some examples, a user may manually intervene in a cooking process, such as where an appliance setting mode is changed or the user manually intervenes to set the time and temperature values. In cases like these, the system 100 can re-run scripts on open/close of the appliance door 138 or a change of setting. In some examples, system suggestions are applied automatically only on the first run. Other interruptions and other edge cases can require the user to set their own time and temperature again.

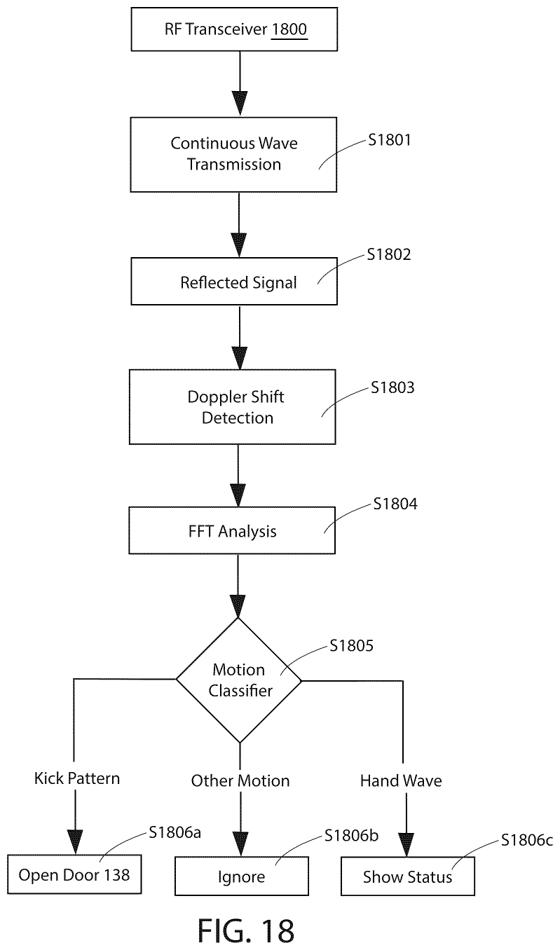

With reference to FIG. 18, an example schematic illustrating operative process of one or more motion sensors 125 of a cooking appliance 104 of present disclosure having one or more motorized doors 138 is shown. Motion sensors 125 can use radio-frequency (RF) transceiver 1800 that does continuous wave transmission S1801. In the given example, if the motion sensors 125 detect physical movement through reflected signal S1802, doppler shift is detected S1803 for Fast Fourier Transform (FFT) analysis S1804. The motion is then classified S1805, for example, as “Kick Pattern”, “Other Motion”, and “Hand Wave”. If the motion is classified as “Kick Pattern”, the door 138 of the cooking appliance 104 will be opened S1806a. If the motion is classified as “Other Motion”, it will be ignored S1806b. If the motion is classified as “Hand Wave”, the cooking appliance 104 will show status of its operation S1806c.

The door 138 can be motorized to automatically open and close. Motion sensors 125, such as hands-free radar using ultra-wideband (UWB), ultrasonic, Bluetooth, or other types of radio frequency (RF) can be utilized for a hand waving or kick sensor motion. If the user's hands are full or dirty, they would want a seamless way to put the food into the chamber. Utilizing these RF features would allow the specific hand, foot, or other motion to automatically open the motorized power door 138 and start cooking when a weight difference is detected inside the enclosure 106. User distance from the cooking appliance 104 can be measured using Bluetooth channel sounding, or other similar techniques known in the art, to determine when the user is walking towards or away from the cooking appliance 104. Distance data characteristics and patterns can be trained through machine learning techniques to improve accuracy and experience for users.

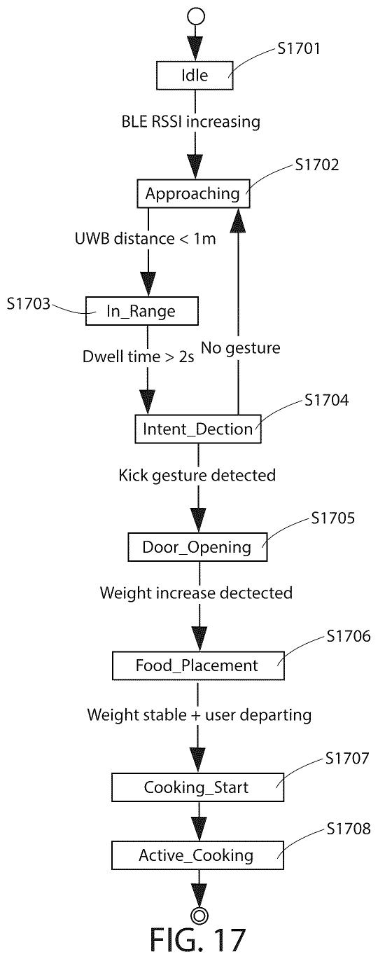

With reference to FIG. 17, an example of motion sensor 125 sequence is shown. Motion sensor 125 of the cooking appliance 104 will be in an idle state as shown in sequence S1701 until Bluetooth Received Signal Strength Indicator (BLE RSSI) increases, which indicates a user is approaching as indicated in S1702. If UWB distance is less than 1 m, then the user is in range as indicated in S1703, and if the user dwells in front of the motion sensor 125 for greater than 2 seconds, it is considered the intent of the user to use the machine, and the system 100 enters the intent detection sequence S1704. If no gesture is detected, the system 100 loops back to the approaching sequence S1702. If kick gesture is detected, the system 100 enters the door opening sequence S1705. If the user places a food item 700 in the cooking appliance 104 and the weight increase is detected by the force transducers 128, the system 100 enters the food placement sequence S1706. If the food item weight is stable and the motion sensor 125 detects the user is moving away from the cooking appliance 104, the system 100 enters the cooking start sequence S1707, and actively starts cooking S1708.

In some examples, the system 100 includes a “feedback system” to tailor subjective user opinions about their food into cooking parameter adjustments on the cooking appliance 104 to produce a more desirable outcome. Different people like their food prepared in different ways. To some, perfect may be medium-rare on a steak, while for others it may be well-done. For baked goods, some may prefer soft and chewy, while others prefer crunchy. By ingesting user feedback provided through a corresponding web or mobile application and through backend software, local cooking preferences can be individually personalized for different users of the cooking appliance 104. In addition, by persisting the data, the system 100 can analyze the data and provide common presets for different definitions of food “done-ness.”

In some examples, the system 100 can collect data on time, location, type of food, and end result of the food that is being cooked. This enables an entire ecosystem where users can share their testing cooking preferences and styles with other users around the world. Global and local preferences will also be created, guiding users' initial cooking habits. For example, if the device is being enabled in a certain region, the initial food preferences can sync with how people in that local region enjoy their food. This allows for an automated startup for preferences, helping determine the precision that the user wants. These preferences locally around the world are then compiled and averaged out to determine the overall global preferences for each food around the world, and becomes a part of the global model. With this data, grocery stores can better supply food options based on the local preferences of the users who cook in the geographical area. With a connected system, automated delivery food services can become more intelligent. They can start predicting trends based on how many items were bought vs cooked over time to start allowing for a seamless grocery experience for the user. They no longer have to keep track of the current food options in their fridge, but rather, the system will do so. It can connect to food services wirelessly and make transactions based on the user's cooking behavior.

In some examples, the cooking appliance 104 can send push notifications to a companion application on the user's mobile phone 108 about state changes to the system 100, such as if the cooking process has stopped due to the appliance door being opened. Users can watch the temperature chart of readings from the IR sensor(s) 124 to see if there are anomalies and stop the cooking process at any time. They can also see the progress of the cook through a stream of captured images of the food item at discrete timesteps.

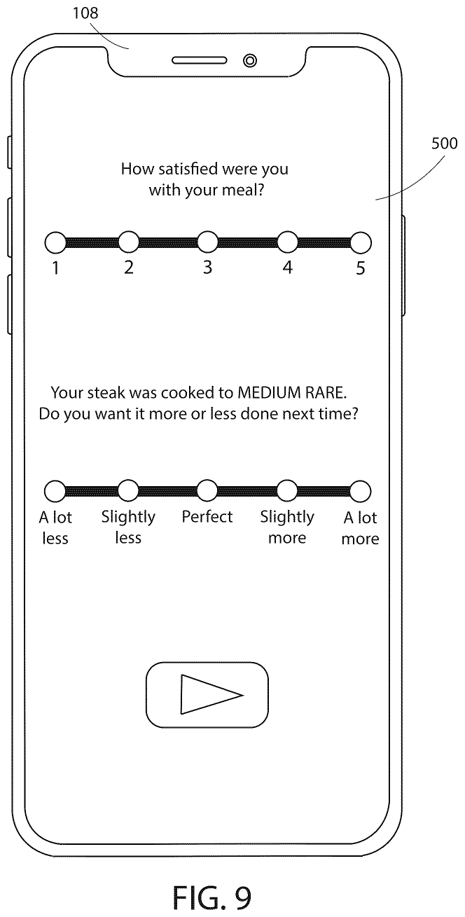

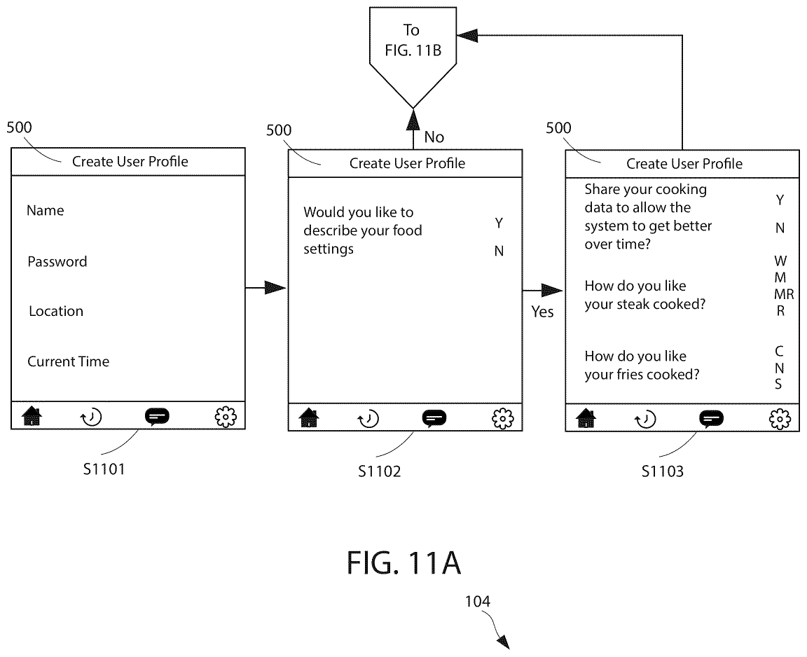

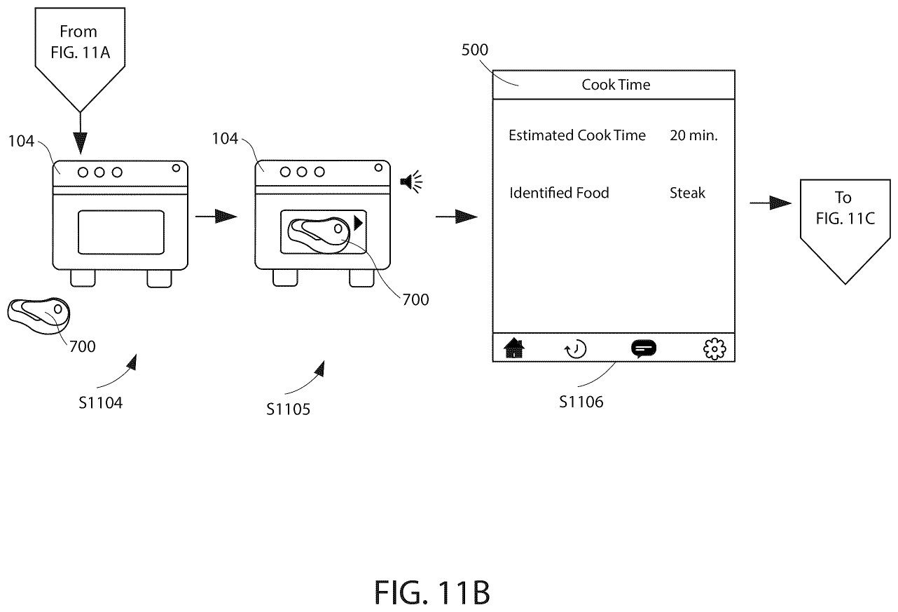

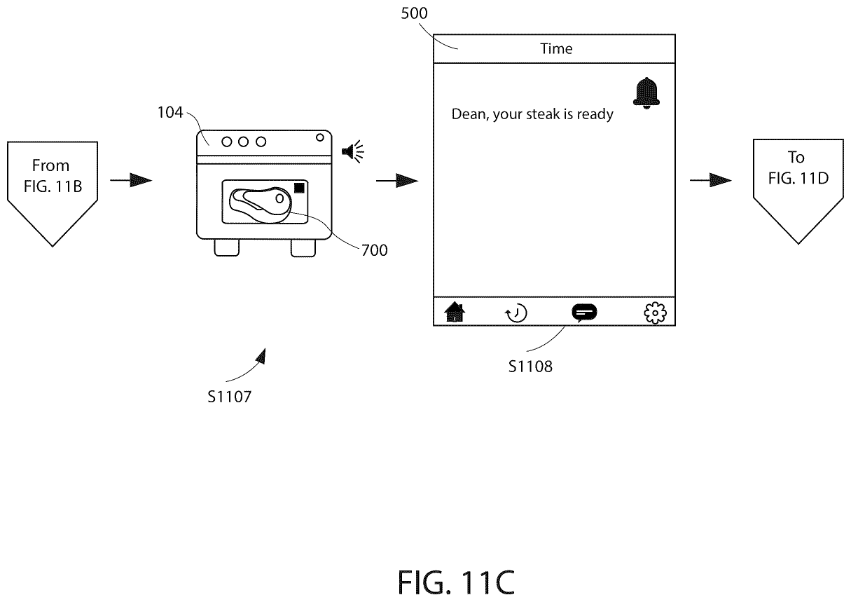

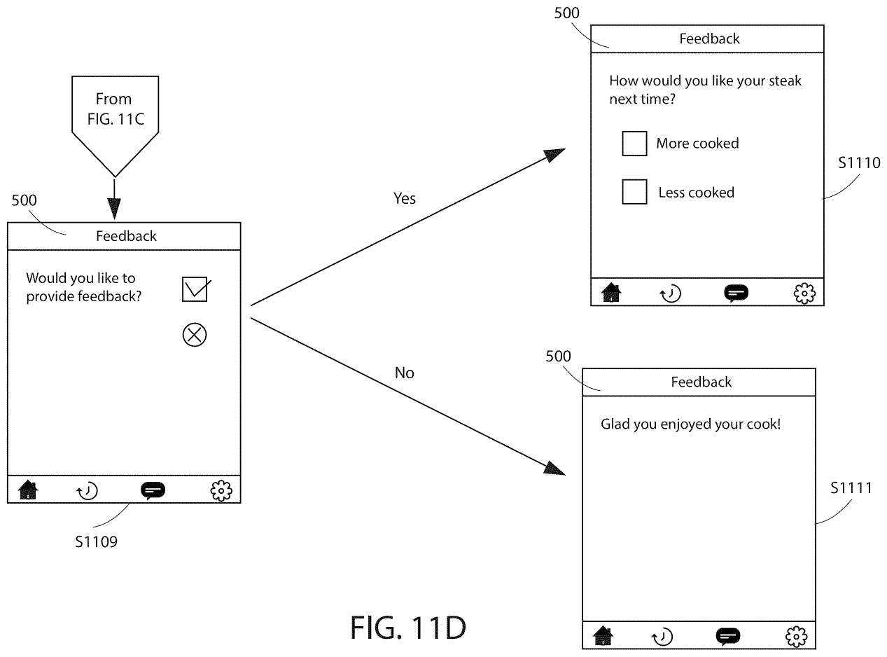

On termination of a cooking session, the system 100 prompts the user for feedback on the cooked food item from a subjective taste perspective (see FIGS. 11C-11D). If they do not provide feedback, no adjustments to the cooking parameters are made. In some examples, the companion application presents input elements, such as radio buttons (see FIG. 9) or sliders, which allow the user to provide feedback. Such feedback input can include overall satisfaction as well as food specific evaluations, depending on what was cooked. FIG. 9 illustrates one example user interface 500 for providing feedback.

Different forms and types of feedback can be requested for each food item. For example, a user may evaluate a cooked steak based on its “done-ness,” i.e., the steak's cooked condition, and may input requests for the cooking appliance 104 to produce different conditions with the next steak to be cooked. Other evaluation parameters can include the steak's level of juiciness and crust formation. In another example, French fries can be evaluated in user feedback based on their crispness and brown-ness as a subjective dimension.

In some examples, images captured at different points in time during the cooking process can be utilized to correlate visual properties of the cook to these subjective values. For example, the user can see at which point in time the system 100 estimated a steak to be rare vs medium rare, and the user can base their evaluation and feedback at least in part on a corresponding visual image of the steak.

After the user provides the system 100 with feedback on subjective taste, texture and/or other food item properties, the feedback is mapped to numeric values and can be stored as a vector. The vector is passed to a feedback backend service which computationally adjusts the cooking parameters based on the type of food that was cooked. For example, if a user provided input that the steak was too well-done, the backend service adjusts the temperature and/or time so that the target output condition on their next cook is achieved. In some examples, the preferences for each user are updated individually using this method:
Multiplying or dividing the set time by a weighted average;
Averaging cook time for all of a user's cooks and multiplying that by a weighted value based on the user's feedback.

Feedback data can also be anonymously aggregated for global adjustment and recommendation purposes for other cooking appliances and users.

In some examples, by leveraging sensor 116 data from the cooking appliance 104, including weight data, the system 100 can estimate calories and macronutrients of a food item before being cooked, and automatically sync them with fitness and health applications for convenience to the user. In these examples, the user simply places the food item inside of the cooking appliance 104, thereby avoiding other cumbersome steps such as pulling out their phone and scanning a barcode or manually entering nutritional data, such as the many details of the nutritional information of the food item, such as macronutrients, micronutrients, quantity, food brand, and all other food information. Advantageously, the system 100 can identify food items and map them to common nutritional profiles, and can determine the serving size of that food using the force transducer(s) 128. In this manner, the system 100 can conveniently, automatically, and accurately estimate the overall calories, macronutrients and micronutrients of a food item. Any data related to a food item, including serving size, calories, macronutrients, micronutrients, quantity, food brand, etc. can be considered nutritional data for the purposes of this disclosure.

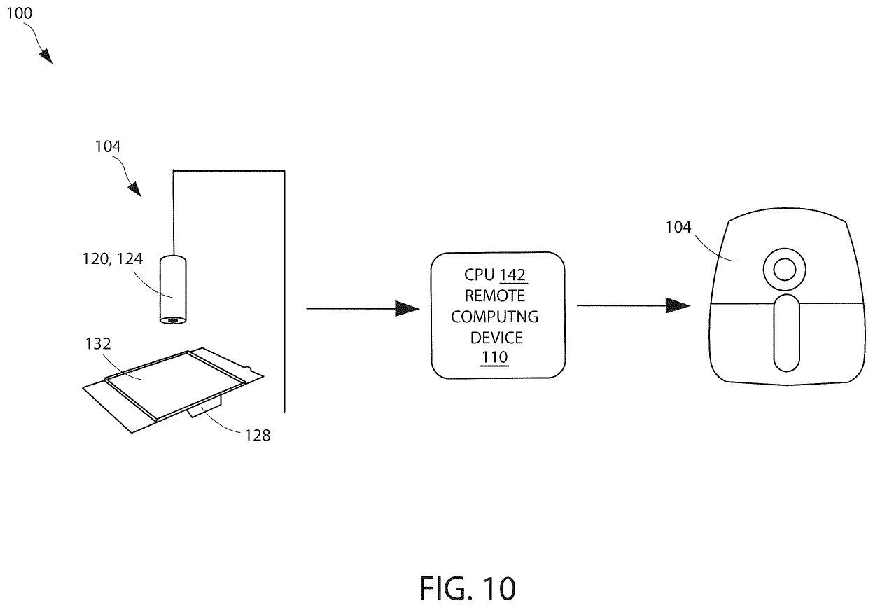

FIG. 10 is a schematic depiction of components of a system 100 for cooking a food item according to examples of the present disclosure. The system 100 contains force transducer 128, which can be a scale 128, for determining the weight of a food item. The system 100 also contains infrared sensor 124 that is used to determine initial temperature of the food item, and a visual light camera 120 for food recognition. The various sensors 120, 124, 128 of the system 100 communicate information about a food item 700 with programs on the CPU (processor) of a computing device/system 108, 110, 200, which can also be in the cooking appliance 104 itself.

FIGS. 11A-11D are a schematic depiction of an example process for operating a system 100 to cook a food item 700 using a cooking appliance 104 according to examples of the present disclosure. FIG. 11A illustrates an example user interface 500, which could be on a mobile device 108 (see FIG. 1) or any other computing device. A user is prompted to create a user profile at step S1101 and then prompted to see whether the user wants to set up their food settings at step S1102. A user can skip and proceed with cooking operations (FIGS. 11B-11D), or input predetermined user preference at step S1103, which is collected by the cooking system 100 as user food data for global and local user food preferences profiles generation. User food data is any data related to a specific user and their food preferences, such as, but is not limited to food preferences, user feedbacks, user profile, predetermined user preferences, types of food items cooked, portions and amount of food, doneness, etc.

Then, in reference to FIG. 11B, the user can proceed with placing a food item 700 into the cooking appliance 104 at S1104 and the cooking of the food item 700 will start as shown in step S1105. The user can be given visual or auditory signal that the cooking process has started. Once the cooking appliance 104 starts up, it will use its various sensors (see FIG. 3) to classify the food item 700 as a predicted food class and then determine a cooking time and cooking temperature for the food item 700 using thermal modeling. As shown in S1106, the user will be shown estimated cooking time as well as the identity of the food item 70 on the user interface 500. In some embodiments, cooking temperature also may be displayed to the user.

In reference to FIG. 11C, once the food item 700 has finished cooking, the cooking appliance 104 will automatically stop the cooking process, and alert the user via visual or auditory signals in step S1107. The user interface 500 will also let the user know that the food item 700 has finished cooking as shown in S1108.

In reference to FIG. 11D, once the cooking appliance 104 has finished operations, the system 100 will ask the user through the user interface 500 to provide feedback as shown in S1109. The user can either choose to provide personal feedback as shown in S1110 or do not provide feedback and the system 100 will finish operation as shown in S1111. The received user feedback will be used to improve the cooking system 100 performance through fine tuning thermal models and other models used in operation of the system 100.

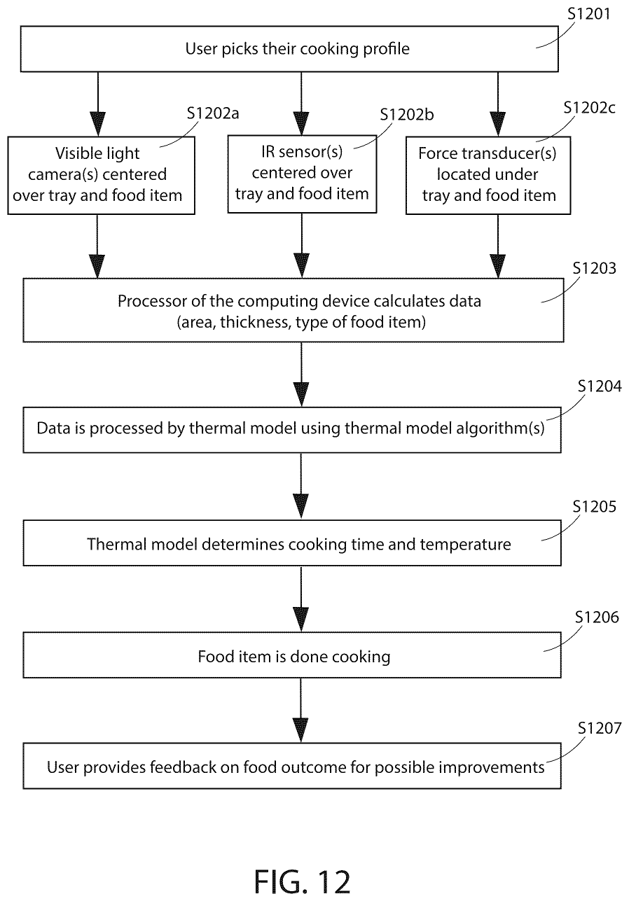

FIG. 12 is another schematic depiction of a process for operating a cooking appliance 104 to cook a food item 700 according to examples of the present disclosure. The user chooses their cooking profile (see FIG. 11A) in step S1201 then the system 100 begins collecting data about the food item 700 from visible light camera(s) 120, IR sensor(s) 124, and force transducer(s) 128 in steps S1202a-c. Processor 202 of computing system 200 (or processor 142 of a remote computing device 110) then calculates additional data, such as area, thickness, type of food item 700, etc. at step S1203. These data are processed by the thermal model using thermal modeling algorithms 140 at step S1204 to then determine cooking time and temperature at step S1205. The system 100 executes the cooking process, and then once the food is done cooking at step S1206, the user is prompted for feedback to improve the system 100 at step S1207.

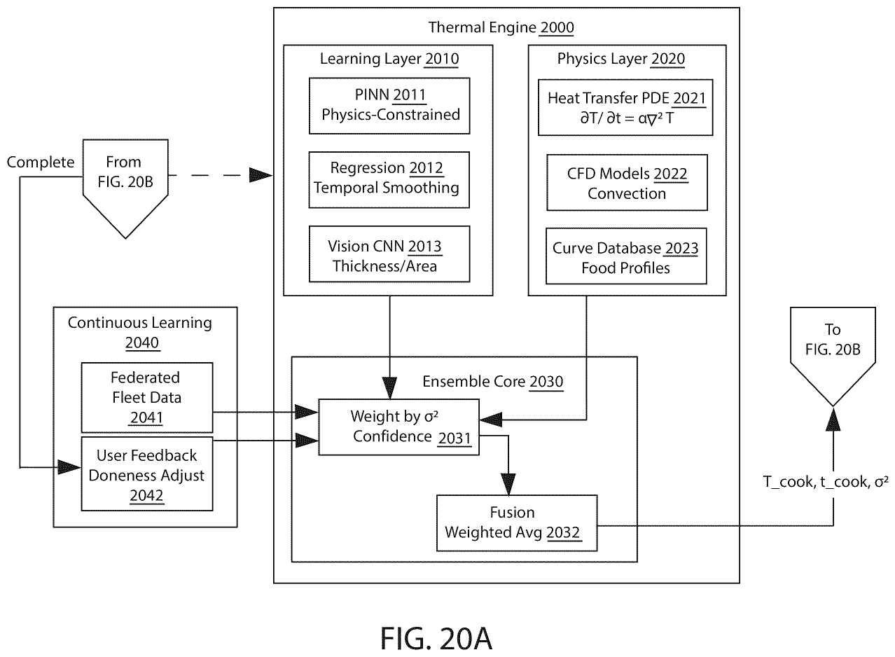

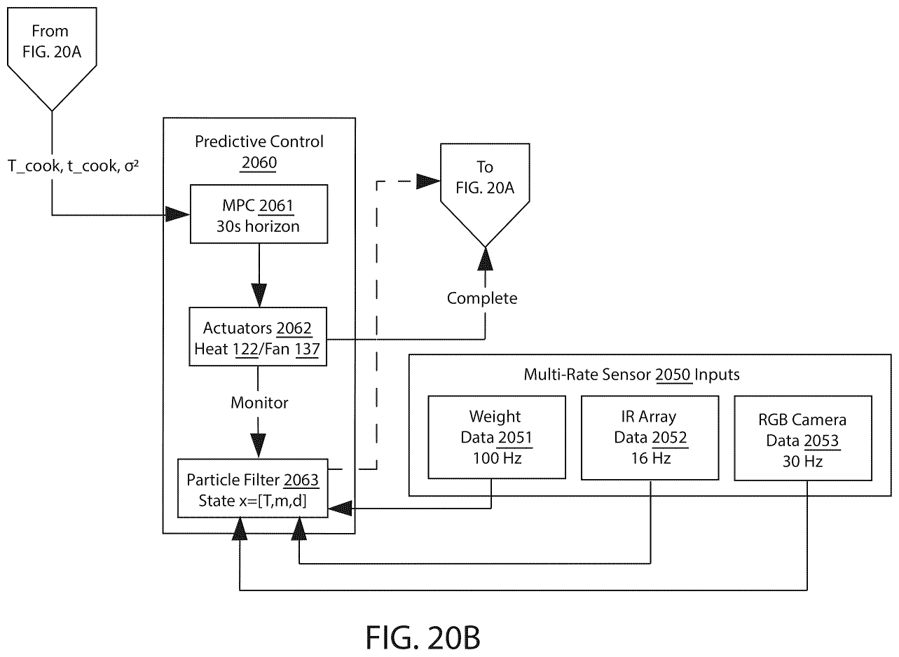

In reference to FIGS. 20A-20B, another embodiment of the system 100 is shown, similar to that of FIGS. 14A-14B. In this embodiment, an engine 2000, also referred to as thermal engine 2000, receives particle filtered data processed by particle filter 2063 after receiving data from multi-rate sensor inputs 2050 sensors (such as data 2053 from the visible light (RGB) camera(s) 120, data 2052 from IR sensor(s) 124, data 2051 from force transducer(s) 128, and data from motion sensor(s) 125 (not shown in FIGS. 20A-20B), etc.) that are under the predictive control 2060 executes the thermal modeling algorithm 140 with received data, then uses the resultant data to output commands to the cooking appliance 104. In some embodiments, the engine 148 may contain additional features for processing data, such as a learning layer 2010 (comprised of a physics constrained PINN 2011, regression 2012 for temporal smoothing, and a vision convolutional neural network 2013 for determining thickness and area of a food item, for example), physics layer 2020 (comprised of heat transfer partial differential equation (PDE) 2021, CFD models 2022, and curve database 2023), and an ensemble core 2030 that determines the weighted standard deviation for confidence 2031 and then fuses the weighted averages 2032. The weight standard deviation 2031 may also be determined by the ensemble core 2030 by obtaining data from continuous learning sources 2040, such as from federated fleet data 2041, user feedback 2041, etc. Predictive control 2060 includes controlling model predictive control (MPC) 2061 and components of the cooking appliance 104 such as actuators 2062 for heating elements 122 and fans 137.

In some embodiments the cooking appliances 104, methods for operating a cooking appliance 104 to cook a food item, and related models, algorithms 140, engines 148, and other components described herein may be utilized with a computing system of one or more computing devices 110. Similarly, the methods and processes described herein may be implemented as a computer-application program or service, an application programming interface (API), a library, and/or other computer-program products. FIG. 13 schematically shows a non-limiting embodiment of a computing system 200 configured to provide any to all of the compute functionality described herein. Computing system 200 is shown in simplified form.

The cooking appliance 104, mobile phone 108, and remote computing device 110 described above may comprise computing system 200 or one or more aspects of computing system 200. Computing system 200 may take the form of one or more laptops, personal computers, server computers, tablet computers, home-entertainment computers, gaming devices, mobile computing devices, mobile communication devices (e.g., smart phone), wearable computing devices, and/or other computing devices.

Computing system 200 includes a logic processor 202, volatile memory 204, and a non-volatile storage device 206. Computing system 200 may optionally include a display subsystem 208, input subsystem 210, communication subsystem 212, and/or other components not shown in FIG. 13.

Logic processor 202 includes one or more physical devices configured to execute instructions. For example, the logic processor 202 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 202 may include one or more physical processors (hardware) configured to execute software instructions. Additionally or alternatively, the logic processor 202 may include one or more hardware logic circuits or firmware devices configured to execute hardware-implemented logic or firmware instructions. Processors of logic processor 202 may be single-core or multi-core, and the instructions executed thereon may be configured for sequential, parallel, and/or distributed processing. Individual components of the logic processor 202 optionally may be distributed among two or more separate devices, which may be remotely located and/or configured for coordinated processing. Aspects of the logic processor 202 may be virtualized and executed by remotely accessible, networked computing devices configured in a cloud computing configuration. In such a case, these virtualized aspects are run on different physical logic processors 202 of various different machines, it will be understood.

Volatile memory 204 may include physical devices that include random access memory (RAM). Volatile memory 204 is typically utilized by logic processor 202 to temporarily store information during the processing of software instructions. It will be appreciated that volatile memory 204 typically does not continue to store instructions when power is cut to the volatile memory 204.

Non-volatile storage device 206 includes one or more physical devices configured to hold instructions executable by the logic processors 202 to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), magnetic memory (e.g., hard-disk drive, floppy-disk drive, tape drive, MRAM, etc.), and/or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines 148 may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. As the herein described methods and processes change the data held by the non-volatile storage device 206, and thus transform the state of the non-volatile storage device 206, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

Input subsystem 210 may comprise or interface with one or more user-input devices such as touchpad, keyboard, touch screen display, a mouse, electronic pen, stylus, or game controller. In some embodiments, the input subsystem 210 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network, such as an HDMI over Wi-Fi connection, Bluetooth, or ultrawideband (UWB) protocols. In some embodiments, the communication subsystem 210 may allow computing system 200 to send and/or receive messages to and/or from other devices via a network 112 (see FIG. 1) such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

And/or” as used herein means any or all of multiple stated possibilities. For example, the phrase “element A and/or element B” covers embodiments having element A alone, element B alone, or elements A and B taken together.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for operating a cooking appliance to cook a food item, the cooking appliance comprising one or more visible light cameras, one or more infrared sensors, and one or more force transducers, the method comprising:
determining an external temperature of a surface of the food item using data from the one or more infrared sensors;
estimating an internal temperature of the food item using the external temperature;
using data from the one or more visible light cameras, classifying the food item as a predicted food class from a plurality of food classes;
determining a weight of the food item using data from the one or more force transducers;
using at least the internal temperature, the predicted food class, and the weight of the food item, generating a temperature profile of the food item;
using at least the temperature profile, determining a cooking time and a cooking temperature for the food item; and
causing the cooking appliance to cook the food item at the cooking temperature for the cooking time.
comprising inputting data from one or more sensors selected from the group consisting of the one or more visible light cameras, the one or more infrared sensors, and the one or more force transducers into a thermal model to generate the temperature profile for the food item.

5. The method of claim 1, further comprising determining a recommended method of cooking the food item.

6. The method of claim 1, further comprising:
receiving user feedback comprising satisfaction criteria corresponding to the food item after cooking; and
using the user feedback to adjust one or more of the cooking time and the cooking temperature.

8. The method of claim 1, further comprising improving data by utilizing sensor fusion on data from the one or more visible light cameras, the one or more infrared sensors, and the one or more force transducers.

10. The method of claim 1, further comprising using at least one of data from the one or more visible light cameras, the one or more infrared sensors, and the internal temperature, the predicted food class, the temperature profile, the cooking time, and the cooking temperature to estimate nutritional data.
inputting data from one or more sensors selected from the group consisting of the one or more visible light cameras, the one or more infrared sensors, the one or more force transducers, and the one or more motion sensors into a thermal model to generate commands to be executed by the cooking appliance, wherein the commands at least comprising opening or closing the one or more motorized doors.

12. A cooking system, comprising:
a cooking appliance comprising:
an enclosure;
a heating element configured to heat a food item inside the enclosure;
one or more visible light cameras in the enclosure;
one or more infrared sensors in the enclosure;
one or more force transducers;
a processor;
a communication unit; and
a memory; and
a cloud service in communication with the communication unit of the cooking appliance, comprising:
at least a processor and a memory;
wherein at least one of the memory of the cooking appliance and the memory of the cloud service storing instructions executable by a corresponding processor to:
determine an external temperature of a surface of the food item using data from the one or more infrared sensors of the cooking appliance;
estimate an internal temperature of the food item using the external temperature;
using data from the one or more visible light cameras of the cooking appliance, classify the food item as a predicted food class from a plurality of food classes;
determine a weight of the food item using data from the one or more force transducers of the cooking appliance;
using at least the internal temperature, the predicted food class, and the weight of the food item, generate a temperature profile of the food item;
using at least the temperature profile, determine a cooking time and a cooking temperature for the food item; and
cause the cooking appliance to cook the food item at the cooking temperature for the cooking time.
executable by the corresponding processor to:
use a predetermined user preference and the temperature profile when determining the cooking time and the cooking temperature; and
determine a layer temperature at a plurality of layers of the food item when generating the temperature profile.
input data from one or more sensors selected from the group consisting of the one or more visible light cameras, the one or more infrared sensors, and the one or more force transducers into a thermal model to generate the temperature profile for the food item.
receive user feedback comprising satisfaction criteria corresponding to the food item after cooking; and
use the user feedback to adjust one or more of the cooking time and the cooking temperature.
memory of the cooking appliance and the memory of the cloud service are further executable by the corresponding processor to:
estimate nutritional data of the food item.

17. The cooking system of claim 12, wherein the instructions stored by at least one of the memory of the cooking appliance and the memory of the cloud service are further executable by the corresponding processor to:
improve data by utilizing sensor fusion on data from the one or more visible light cameras, the one or more infrared sensors, and the one or more force transducers of the cooking appliance.

18. The cooking system of claim 12, wherein the cooking appliance further comprises one or more motorized doors and one or more motion sensors, and wherein the instructions stored by at least one of the memory of the cooking appliance and the memory of the cloud service are further executable by the corresponding processor to:
using data from the one or more motion sensors, open and close the one or more motorized doors to cook or stop cooking the food item.

19. The cooking system of claim 12, wherein the memory of the cloud service storing instructions executable by the processor of the cloud service to:
collect user food data received from the communication unit of the cooking appliance to create global and local user food preferences profiles; and
communicate global and local user food preference profiles with computing devices and systems utilized by grocery stores and food delivery services.

20. A cooking appliance, comprising:
an enclosure;
a heating element configured to heat a food item inside the enclosure;
one or more visible light cameras in the enclosure;
one or more infrared sensors in the enclosure;
one or more force transducers;
a processor;
a communication unit; and
a memory storing instructions executable by the processor to:
determine an external temperature of a surface of the food item using data from the one or more infrared sensors;
estimate an internal temperature of the food item using the external temperature;
using data from the one or more visible light cameras, classify the food item as a predicted food class from a plurality of food classes;
determine a weight of the food item using data from the one or more force transducers;
using at least the internal temperature, the predicted food class, and the weight of the food item, generate a temperature profile of the food item;
using at least the temperature profile, determine a cooking time and a cooking temperature for the food item; and
cause the cooking appliance to cook the food item at the cooking temperature for the cooking time.
